(19) United States
(12) Patent Application Publication
(10) Pub. No.: US 2005/0022452 A1
(43) Pub. Date: Feb. 3, 2005

(54) Adjustable facade shell with a carrier frame for a building

(76) Inventors: Paul Schlossbauer, Inning/Stegen (DE); Helmut Sprotofski, Landsberg a.Lech (DE)

Correspondence Address: THE H.T. THAN LAW GROUP, 1010 WISCONSIN AVENUE NW SUITE 580, WASHINGTON, DC, 20007, US

(21) Appl. No.: 10/934,598

(22) Filed: Sep. 3, 2004

Related U.S. Application Data
(63) Continuation of application No. 10/070,215, filed on Feb. 25, 2002.

(30) Foreign Application Priority Data
Jan. 29, 1999 (DE) 199 03 542.3
Mar. 15, 1999 (DE) 199 11 490.0

(51) Int. Cl. E05C 7/02; E05B 65/04; B60J 1/08; B60J 10/02

(52) U.S. Cl. 49/67

(57) ABSTRACT

The invention relates to an adjustable facade shell (1) for a building, having an outer shell (1b) which is formed of panels (2) arranged one behind and/or one over another, which panels are adjustable between a closed position and an opened position, and having an inner shell (1a) spaced from the outer shell (1b) and of one or more wall parts, the adjustment device being arranged on a carrier frame (6) which can be attached to the building and is of vertical and horizontal carrier parts (6a to 6d), and has pivoting devices (4) for the panels (2). For the purpose of reducing the outlay for manufacture and/or installation, the panels (2) are so adjusted by the pivoting devices that in their pivoted out position and during a pivoting procedure they are located in front of the outer side of the carrier frame (6), the inner shell (1a) being connected by means of the carrier parts (6a to 6d) with the outer shell (1d) and being thereby supported.

The invention relates to an adjustable facade shell and to an assembly element and a carrier frame for such a facade shell.

It is known to provide a facade shell of the kind under consideration in single shell or double shell construction. A single shell construction may be considered for functional buildings, for which it is a question of providing protection from wind and weather, whereby by means of an adjustment of the panels the intensity of the ventilation can be set. Double-shell adjustable facades are used for more demanding buildings which are intended for occupation by people, e.g. in high-rise buildings, when despite extreme demands through wind and weather there is required a purposive natural ventilation and temperature increase of the rooms behind of facade, and when overheating of the interior space of the facade is to be prevented. An adjustable facade shell of the kind under consideration is described in WO 96/06258 in a single-shell construction. Such a facade shell forms with an outer wall of a building, e.g. with a windowed face at a side wall or on a roof of the building, a so-called double shell, whereby the adjustable facade shell is located on the outside of the inner shell formed e.g. by the windowed face.

For supporting the outer shell directly on the building, or on a carrier construction formed with vertical posts and horizontal bars and applied to the building, it is known to support the pivot devices for the panels on a carrier having vertical and horizontal outer carrier parts which are mounted individually on the carrier construction or on the building and which in the mounted position form a carrier frame which becomes stable only by means of the fastening of the carrier parts, e.g. to the carrier construction. In a comparable manner there is effected the attachment of an inner shell e.g. formed by means of a fixed glazing or a windowed face, which is held by means of holder frame parts which are attached to inner carrier parts which are mounted on the building. Through this both a great manufacturing outlay and also a great installation outlay are inevitable for the above-described attachment parts, which leads to high manufacturing costs.

The object of the invention is, with an adjustable facade shell or an assembly element or a carrier frame for a facade shell, to reduce the outlay for manufacture and/or installation.

This object is achieved by means of the features of claim 1, 10 or 11. Advantageous developments of the invention are indicated in the subclaims.

With the facade shell according to claim 1, the inner shell is connected with the outer shell by means of the carrier frame and is thereby supported. Through this a number of advantages can be attained. On the one hand, a common carrier frame is provided for the outer shell and the inner shell, whereby the number of carrier parts can be reduced or halved. Further, the width of the construction and the manufacturing outlay can be significantly reduced, whereby it is to be taken into account that with the reduced number of carrier parts the number of the necessary attachment elements also falls. In corresponding manner, the outlay for installation and the installation time is also reduced. Further, the common carrier frame for the outer shell and the inner shell leads to a simple, compact and stable construction whereby positional changes between the outer shell and the inner shell, which could result from expansion of material or cracks in the structure of the building due to settlement, are significantly reduced because the inner shell, the carrier frame and the outer shell form a structural unit.

It is of particular advantage if the carrier parts are formed in one piece with the holder frame parts or integrally formed on the carrier parts. The above-described advantages apply also for such a configuration. Moreover, the carrier parts and the holder frame parts can be manufactured at the same time in combination, whereby the number of the carrier parts is reduced or halved. From this there follows also a significantly reduced outlay in terms of installation, because only half the number of carrier parts must be installed with associated attachment elements. Further, here also a stable construction is attained because the carrier parts and the holder frame parts form a unit carrying the inner shell. Within the scope of the invention it is also possible to attach the holder frame parts to the carrier parts by means of bolts.

With the development according to claim 3, there is provided between the ends of the carrier parts towards one another in each case an attachment device so that a self-supporting carrier frame is provided which can be stably assembled without the means of the carrier construction or of the building, to which the carrier frame can be attached indirectly or directly, in particular can be pre-fabricated at the construction site or in the workshop where the carrier frame is manufactured. Here, the adjustment device can likewise be pre-installed so that after this pre-installation only the installation of the panels and the wall of the inner shell is needed. This applies in particular for the case in which the panels and the inner shell are glass parts. It is however also possible to pre-fabricate the carrier frames with the panels and at least one wall part of the inner shell, as a complete assembly element.

When a common carrier frame is available for the outer and inner shell, which correspondingly extends from the outer shell to the inner shell, particular stabilising features can be attained.

Within the scope of the invention it is possible to integrate carrier frames in accordance with the invention in a post/bar construction, whereby the continuous posts and/or bars form the carrier frame parts of a number of carrier frames arranged next to one another and/or above one another, there being arranged at the opening edges of the posts and bars holder frame parts for associated wall parts of the inner shell.

Below, the invention and further advantages which can be achieved thereby will be described in more detail with reference to preferred embodiments and to the drawings. There is shown:

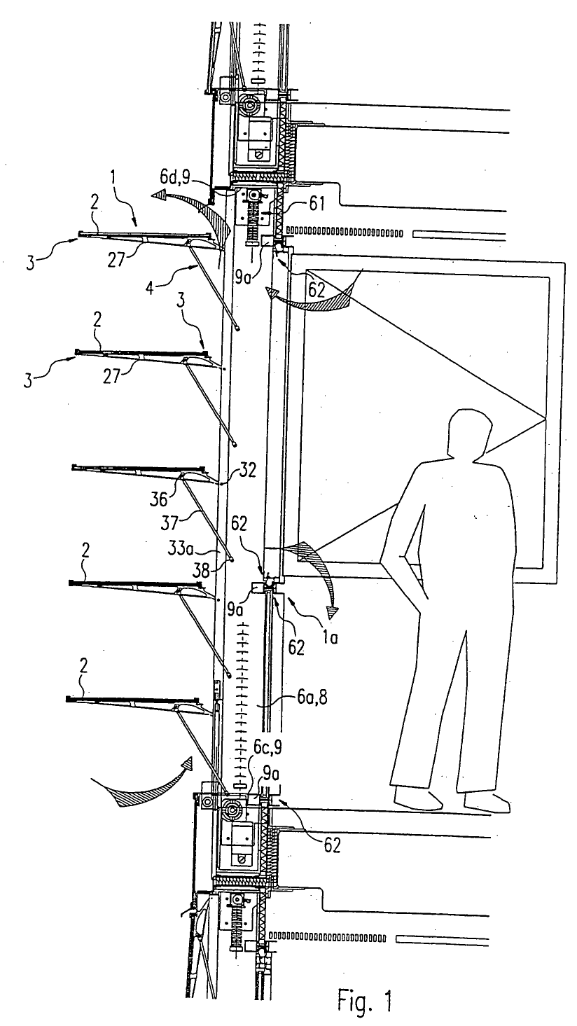

FIG. 1 a facade shell in accordance with the invention in the region of a facade of post/bar construction for a building, in vertical section, the pivotable panels forming the facade shell being in their opened position;

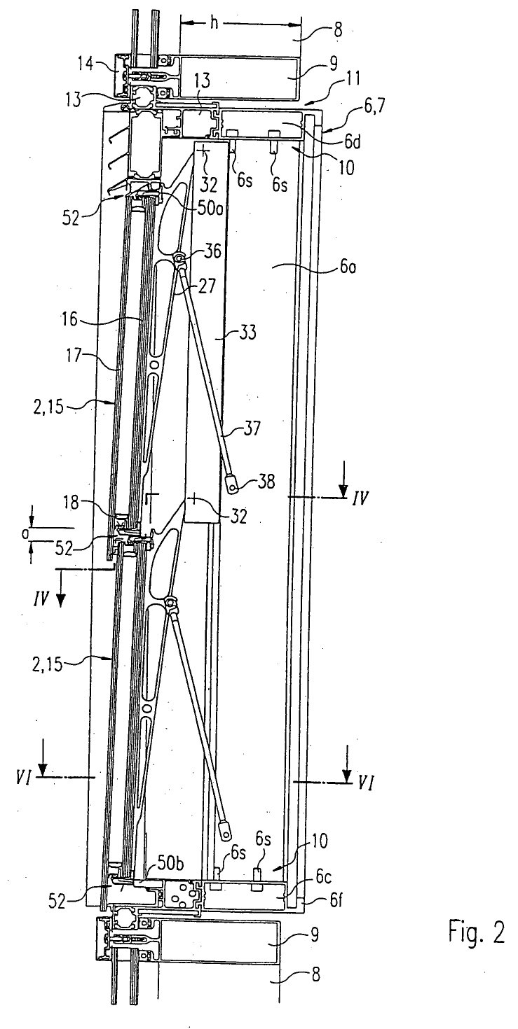

FIG. 2 a facade shell in accordance with the invention in the region of a facade of post/bar construction for a building, in vertical section, the pivotable panels forming the facade shell being in their closed position;

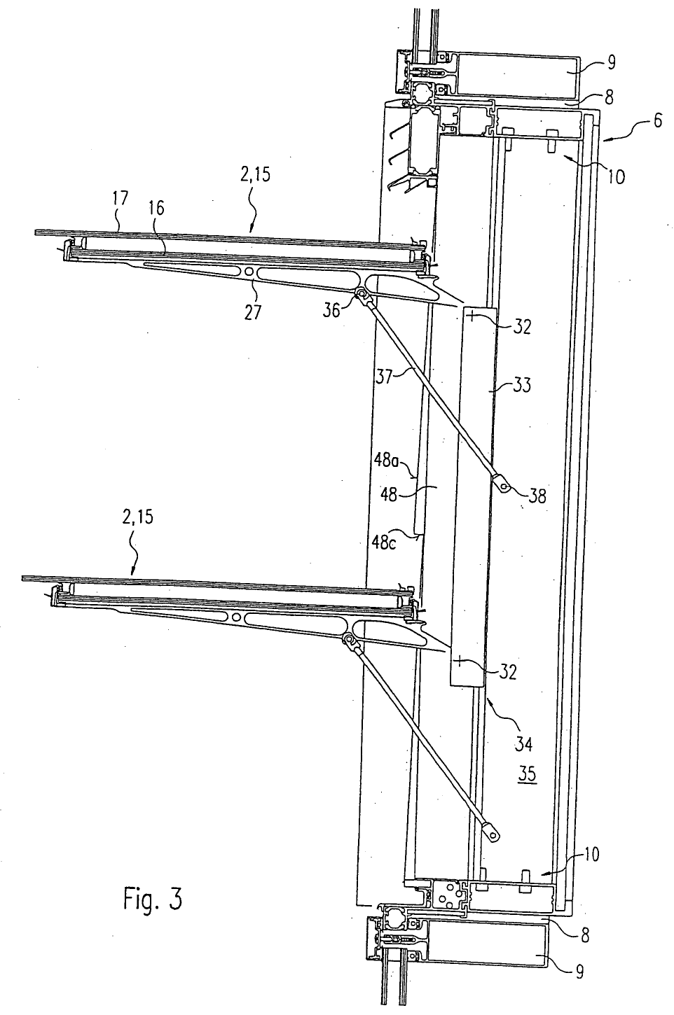

FIG. 3 the facade shell with panels in their opened position;

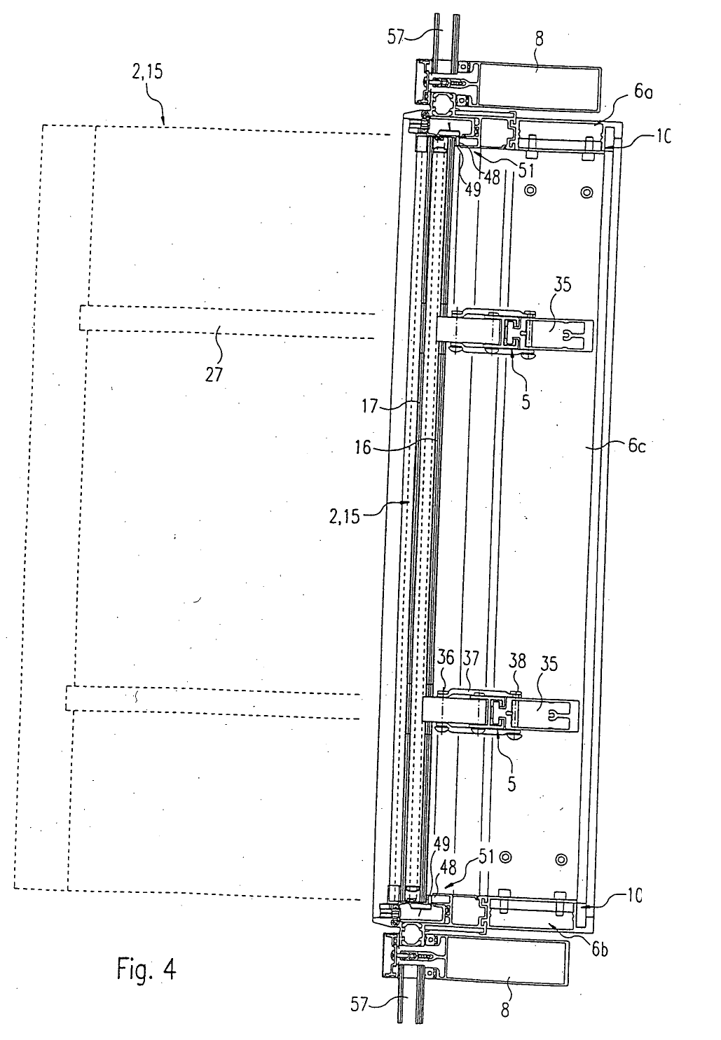

FIG. 4 the partial section IV-IV of FIG. 3;

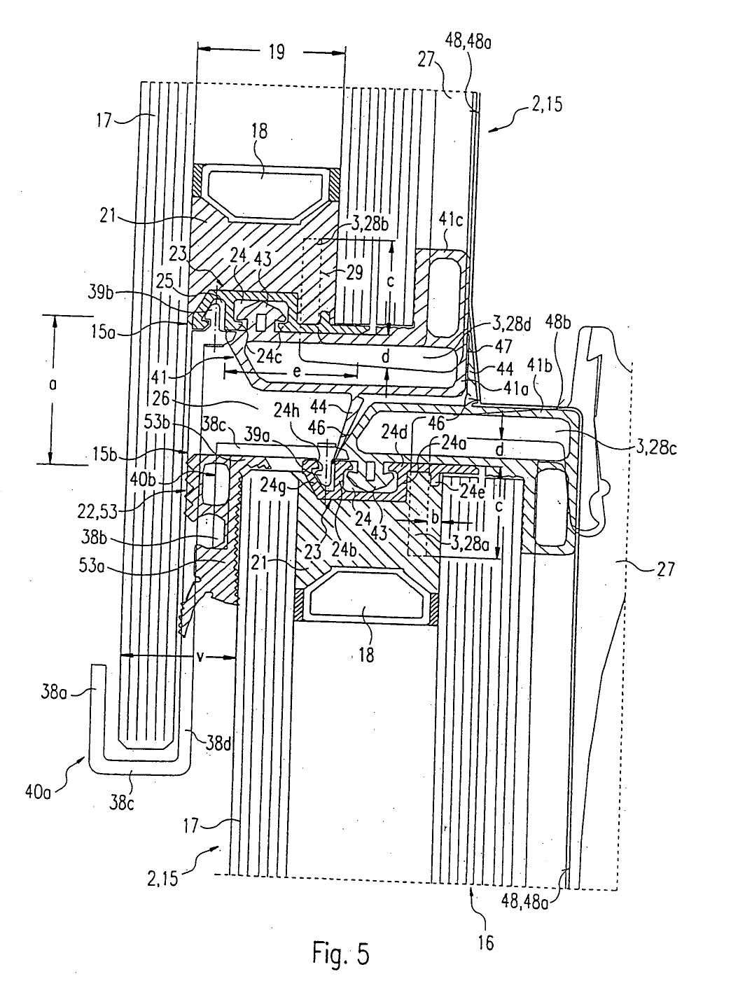

FIG. 5 the overlap region between two panels of the facade shell arranged one over another, in an illustration to an enlarged scale;

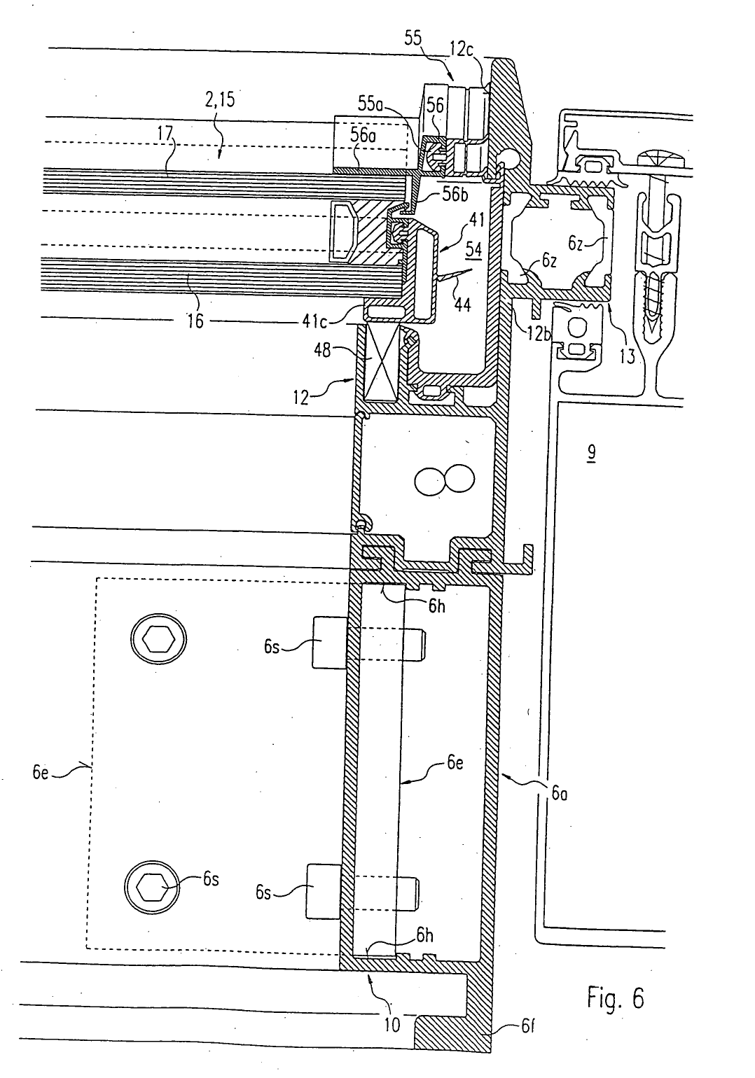

FIG. 6 the partial section VI-VI of FIG. 2;

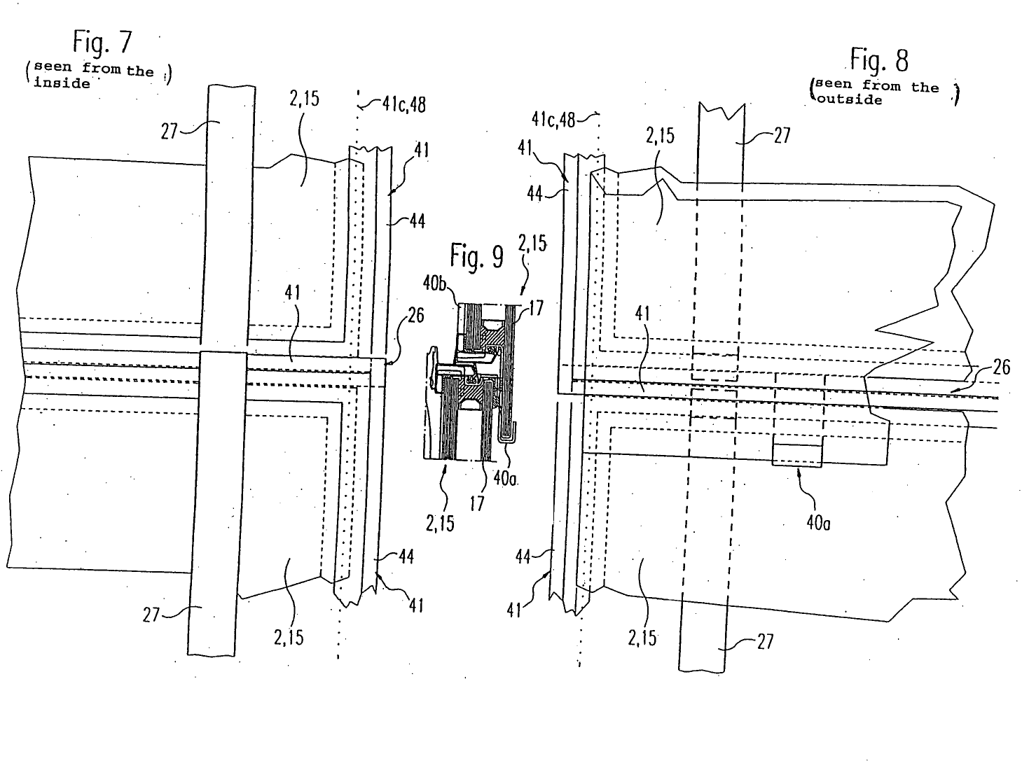

FIG. 7 the overlap region of FIG. 5 in the horizontal end region of two panels seen from the inside;

FIG. 8 the overlap region of FIG. 7 seen from the outside;

FIG. 9 the overlap region in an illustration for comparison with FIGS. 7 and 8;

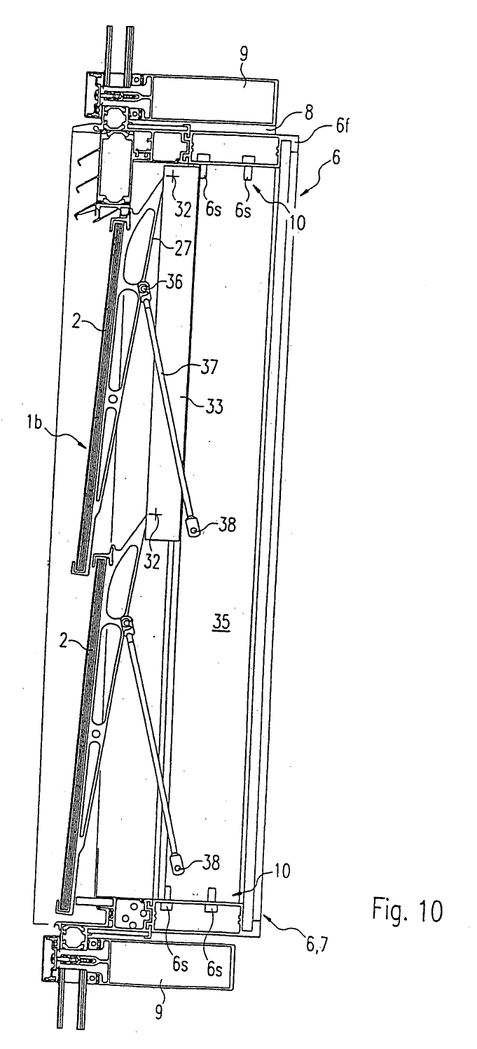

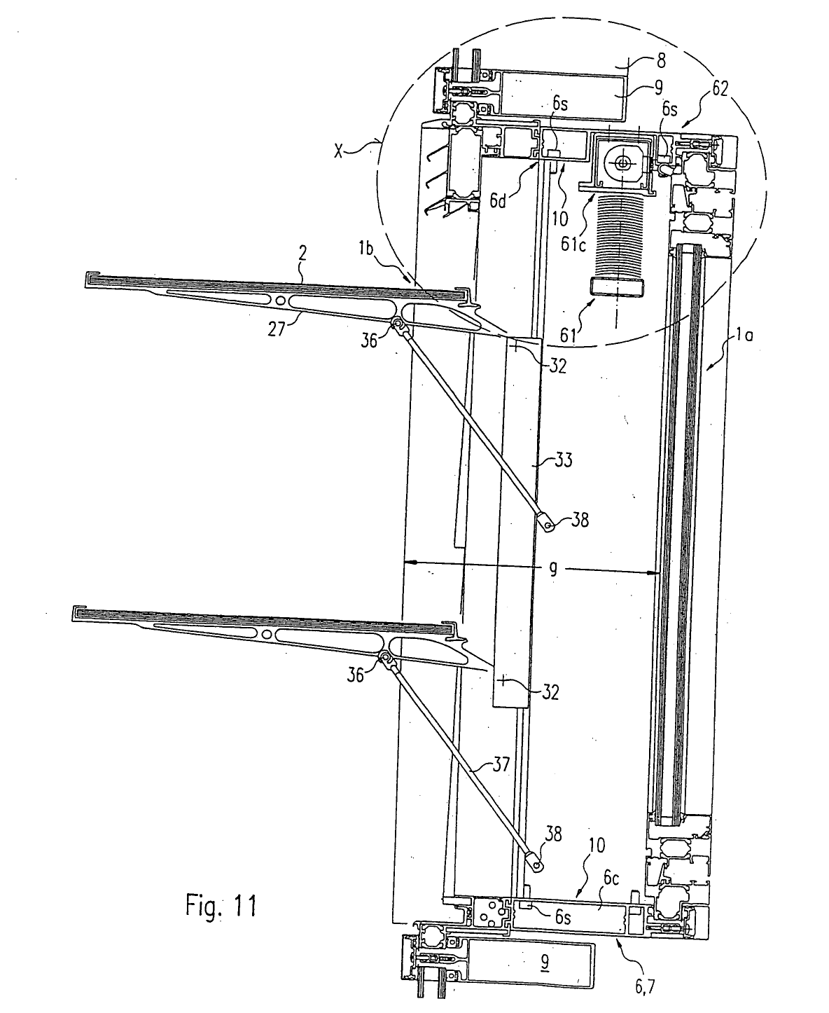

FIG. 10 the facade shell in accordance with the invention according to FIG. 2, with panels in each case consisting of one pane;

FIG. 11 a facade shell according to FIG. 2 or 10, with the panels in the opened position, in a modified configuration as a double shell;

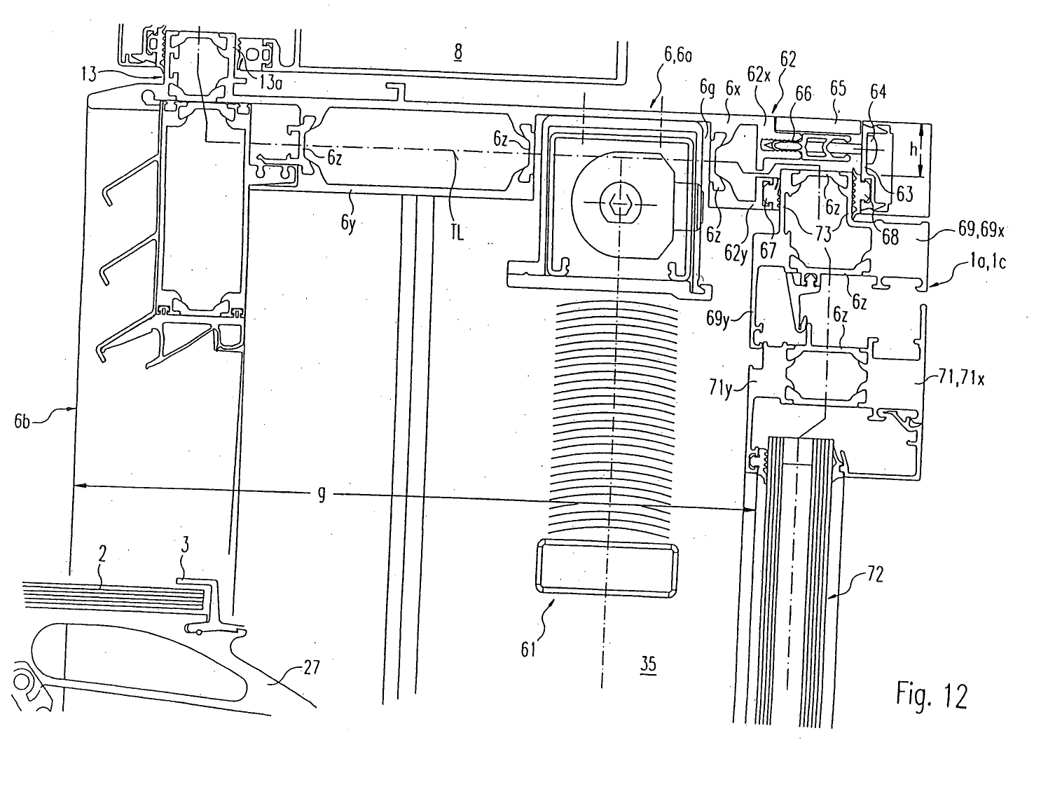

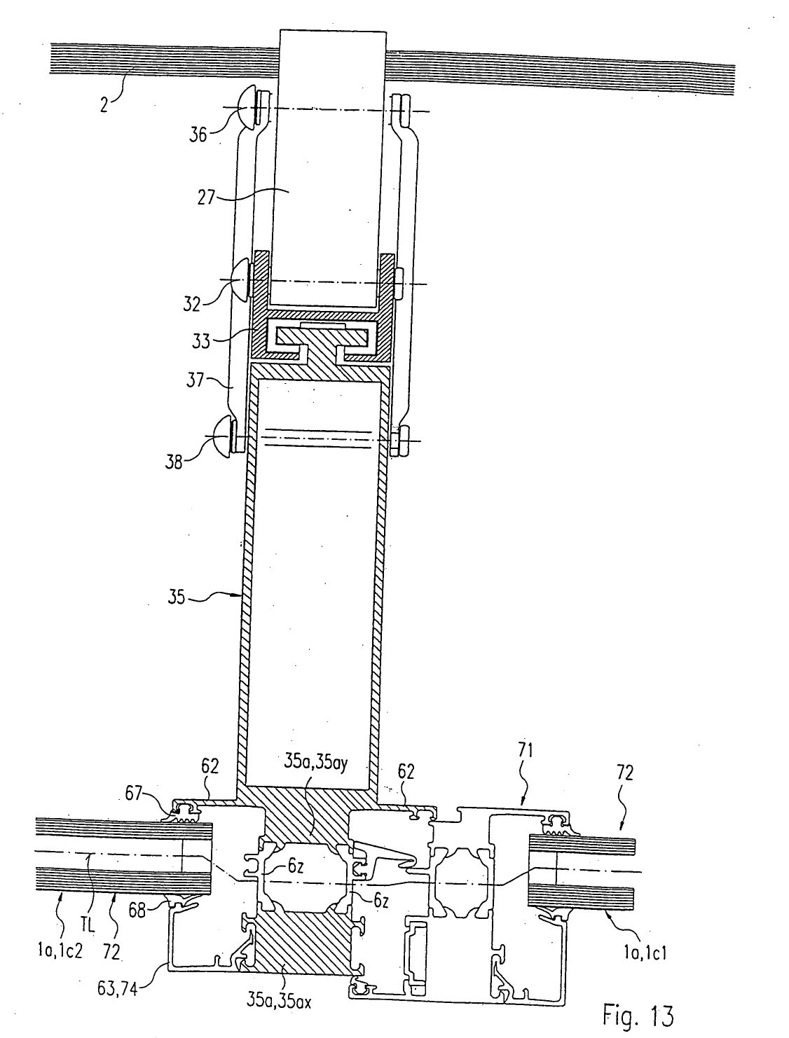

FIG. 12 the detail indicated by X in FIG. 11, in an illustration to an enlarged scale;

FIG. 13 a carrier support of the facade shell in the region of an inner shell;

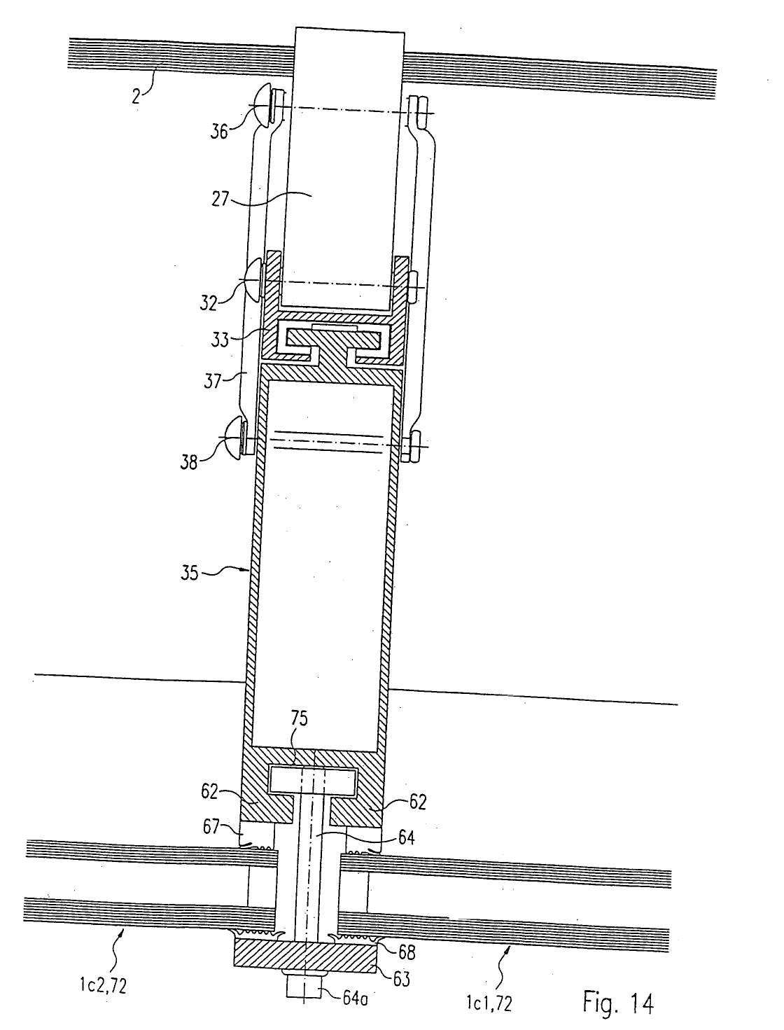

FIG. 14 a carrier support and an inner shell according to FIG. 13, in a modified configuration;

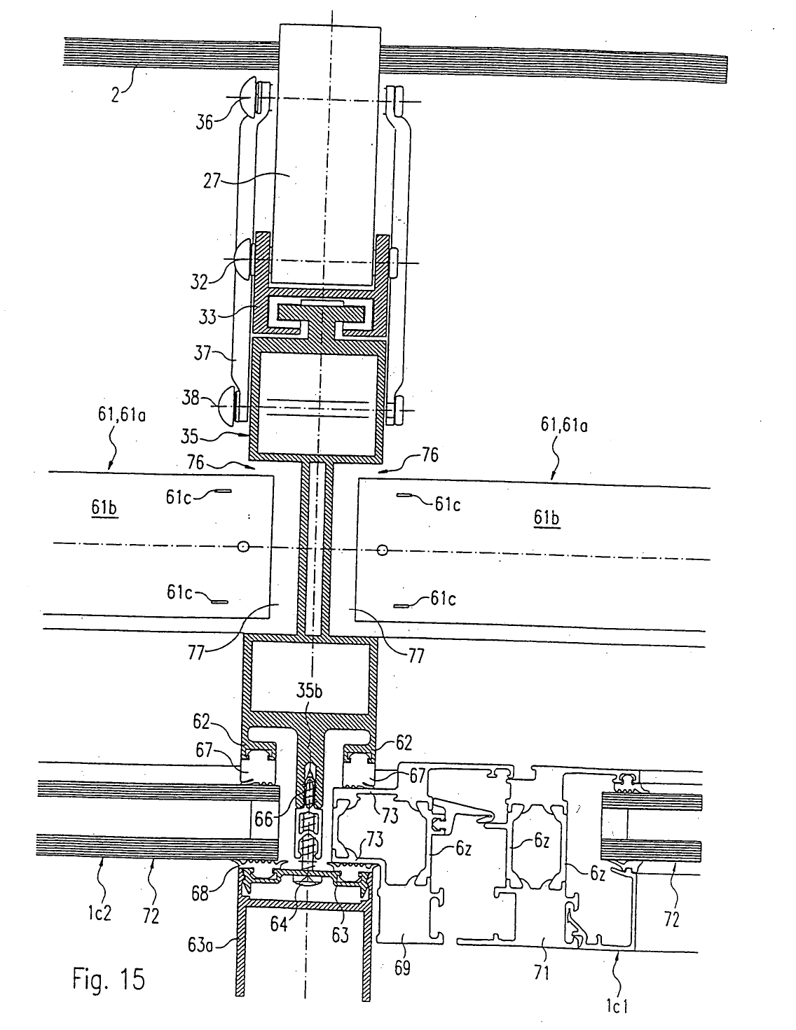

FIG. 15 a carrier support and an inner shell according to FIG. 13, in a further modified configuration;

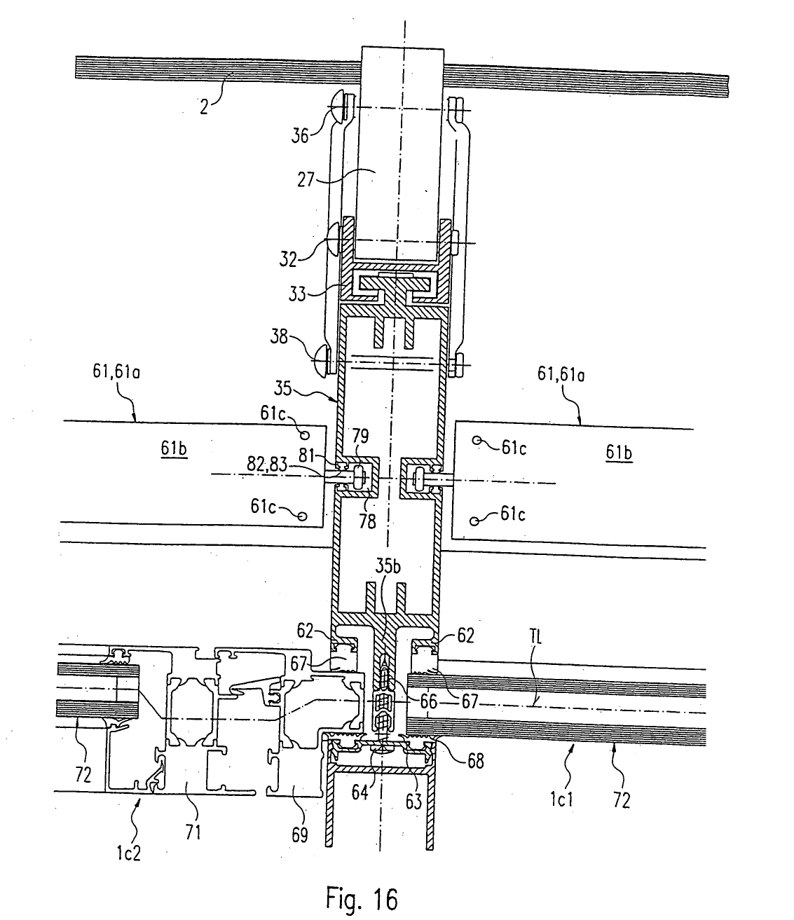

FIG. 16 a carrier support an inner shell according to FIG. 15, in a modified configuration.

The facade shell 1 comprises a plurality of panels 2, which are preferably of glass, e.g. louver glass, and which are arranged one behind another in rows arranged one above another, whereby in accordance with FIG. 1 five rows are present and in accordance with FIG. 2 two rows are present, which with associated holders 3, pivot guides 4 and a common drive 5 are mounted in a wall opening on carrier supports of a carrier construction (FIG. 1) or are integrated into a carrier frame 6 which in accordance with FIG. 2 constitutes a pre-fabricated assembly element 7 which is built into an external wall construction, which is built up with the structure of a post/bar facade. The vertical posts 8 and horizontal bars 9, arranged in a grid-like manner surround in each case an installation opening 11, into which the assembly element 7 can be placed from the outside and mounted on, or in which the carrier arrangement can be installed. There may be a plurality of such installation openings 11 next to one another and/or above one another, in which a carrier arrangement or an assembly element 7 is installed.

The carrier frame 6 of the assembly element 7 consists of two lateral carrier frame parts 6a, 6b, a lower horizontal carrier frame part 6c and an upper horizontal carrier frame part 6d which are fixedly connected to one another in the corner regions, preferably by means of corner angle 6e (FIG. 6). In the outer region, the carrier frame 6 has a continuous mounting flange 13, e.g. made of a profile, which bears against the outer edge of the installation opening 11, whereby the horizontal and vertical mounting flange parts are bolted against both posts 8, present to both sides, and if applicable also to horizontal bars 9, by means of tensioning strips 14 set against them from the outside.

The panels 2 are, also with components mounted thereon which are still to be described, in substance identical to one another and in accordance with FIG. 1 consist each of a glass panel and in accordance with FIG. 2 of a double-skinned insulation unit 15 of glass, the inner pane of which is designated by 16, the outer pane by 17, a spacing frame glued and arranged therebetween by 18, and adhesive bonding material filling the spacing 19 between the panes 16, 17 outside of the spacing frame 18 is designated by 21. At the upper edge of each panel 2 the panes 16, 17 are flush with one another at one height. At the lower edge, the outer pane 17 projects downwardly beyond the inner pane 16, whereby the outer pane 17 overlaps the insulation unit 15 below. As a consequence, in each case the upper insulation unit 15 is, with respect to the insulation unit 15 below, arranged outwardly offset by the amount of the thickness of the outer pane 17 together with the thickness of a seal 22 against driving rain, which is still to be described. Thereby there is present between the lower edge 15a of the upper insulation unit 15 and the upper edge 15b of the lower insulation unit 15 a vertical spacing a of e.g. about 15 mm.

In FIG. 1 an inner shell having a window, of the two-shelled building facade, is illustrated by 1a, which window can be opened and closed as chosen, the panels 2 forming the outer shell 16.

At the outer periphery of the bonding material 21 there is at least at the lower and/or upper edge, preferably all around, a profile strip 23, U-shaped or C-shaped in cross-section, which bounds an outwardly open groove 24 and is at least partially sunk in and embedded in the bonding material 21. In the corner regions the profile strip 23 may be, e.g. mitre cut and if applicable may be fixedly connected to a carrier frame, or there may be arranged at each side an individual profile strip 23 which abut against one another in the corner region. The groove 24 is preferably undercut, in particular on both sides. With the present configuration there are provided at the free edge of the side walls 24a, 24b webs 24c which project towards one another, by means of which the undercut is formed. For improvement of stability it is of advantage to so arrange the profile strip 23 that it at least in part also covers over the inner pane 16, whereby due to the considerably greater rigidity of the inner pane 16 in comparison with the lesser rigidity of the bonding material 21 the fastening of the profile strip 23 is stabilised and forces acting on the profile strip 23 can be transferred to a larger extent via the inner pane 16 to the insulation unit 15. With the present configuration a flat profile limb 24d extends from the free edge of the side wall 24a towards the inner pane 16, at right angles to the panes 16, 17, which profile limb abuts on the outer edge of the inner pane 16 and covers this over at least partially e.g. to the half or entirely. With the present exemplary embodiment, the inner pane 16 is formed by means of a so-called laminated pane in the sense of a double pane. For further stabilisation, there may be arranged at the inner side of the profile limb 24d a small web 24e which penetrates into the bonding material 21 and thus by means of additional embedding stabilises the connection with the bonding material 21.

The groove 24 may serve, in advantageous manner, for the positioning and holding of a sealing profile and/or retaining elements for the panes 16, 17, in particular for the outer pane 17. In order to have a plurality of attachment possibilities or locations available it is advantageous to arrange a profile strip 23 which has two grooves arranged one next to another. With the present configuration, the floor wall 24f of the profile strip 23 is extended towards the outward side and it adjoins to a possible obliquely arranged additional side wall 24g, whereby the second groove 25 is formed. This is preferably likewise undercut at one or both sides, which in the present case is attained by means of a web 24h at the free edge of the side wall 24g projecting inwardly.

The profile strip 23 is, with regard to wall insulation units 15, identically formed, whereby however in the region of the gap 26 between two insulation units 15 arranged one above another a horizontal offset between the associated profile strips 23 occurs because of the overlapping.

The holders 3, identical to one another, for the panels 2 include each at least two pivot mountings or holder arms 27 arranged in the lateral end regions of the panel 2 and engaging under the panel 2, on which pivot mountings there are arranged two pairs of holder webs 28a, 28b, angled or claw-shaped and engaging over and behind the upper and lower edge of the panel 2, of which at least one, here the holder web 28a engaging over, is releasably connected with the holder arm 27. The holder ends of the holder webs 28a, 28b engage behind the inner pane 16 at a spacing b whereby they engage into a receiving hole 29 in the bonding material 21 inwardly of the profile strip 23, which bonding material may be e.g. machined out. When a profile limb 24d is present, the receiving hole 29 extends also through this, whereby it may also here be machined out. For holder webs 28a, 28b of flat cross-sectional shape, as illustrated, it is advantageous to correspondingly configure the receiving holes 29, e.g. in the form of elongate holes. Due to the spacing b and the bonding material 21 present between the respective holder web 28a, 28b and the inner pane 16 the bonding material is protected from the direct engagement of the holder web and held in an elastically damped manner, whereby the bonding material 21 located between the inner pane 16 and the receiving hole 29 acts as damping element.

Preferably a damped mounting is also provided in the vertical, i.e. with respect to the transversely arranged holder web limbs 28c, 28d. With the present configuration this is achieved in that the depth c of the receiving holes 29 is smaller than the associated length of the holder webs 28a, 28b, so that their ends facing one another meet against the base of the receiving hole 29, at least downwardly, and thereby the insulation unit 15 is likewise held in a damped manner, as “between tips” and the upper edges of the inner panes 16 have a spacing d from the holder web limbs 28c, 28d. With panels 2 of greater horizontal lengths there may be arranged more than two holder arms 27, in each case having a horizontal spacing from one another.

The panels 2 are, with the pivoting device 4, selectively pivotable between the closed position illustrated in FIG. 2 and the opened position illustrated in FIG. 3, and fixable in the respective pivoted position. For each panel 2, the pivot device 4 includes a pivot guide consisting of a first joint 32 which is arranged between the upper or inner end of the holding arm 27 and a slider 33, which slider is approximately vertically displaceably mounted in an approximately vertical guide 34 on a vertical carrier profile 35 and can be driven by means of a drive which is not illustrated in detail. Further, the holder arm 27 is mounted pivotally in the pivot plane in a second joint 36 which connects the holder arm 27 pivotally with a support arm 37 which at its other end is mounted pivotally in the pivot plane on the carrier profile 35 in a third joint 38. The pivot guide for the lower panel 2 is also correspondingly constituted, whereby the first joint 32 is arranged deeper on the associated slider 33 than is the first joint 32 of the upper panel, corresponding to the difference in height. When more than two panels 2 are arranged above one another the pivot guide corresponds, whereby the slider 33 should be longer. In the other end region of the panels 2, the pivot guide is correspondingly constituted, whereby for each slider 33 a second guide 34 on a second carrier support is present, whereby the carrier supports 35 are preferably arranged uniformly or symmetrically in the region of the available opening width.

The pivot device 4 is so configured that upon pivoting out into the opened position the panels 2 are located in front of the outer side of the carrier frame 6. Since with this configuration the panels 2 do not move into the inner space surrounded by the carrier frame 6, the inner and outer shells can lie closer to one another and the facade shell can therefore have only a slight structural depth.

When the panels 2 are formed by means of insulation units 15 it is advantageous to provide a holder 3a also for the outer pane 17, in order to secure the outer pane 17 from falling if it should come loose from its bonding with the inner pane. With the present configuration there are provided in each case at least two additional holder webs 38a, 38b which engage under or over and behind the lower edge and/or upper edge of the outer pane 17, which webs are in each case arranged in the lateral end regions of the outer pane and engage into a groove of the profile strip 23, here the second groove 25, and are fixed preferably by means of latching by means of a latching nose 39a, 39b latching behind the web 24h. As can be seen best from FIG. 5, the holder webs 38a, 38b are in each case arranged in an angle shape on holder limbs 38c which engage below or over the outer pane 17, whereby in the case of the holder web 38a engaging below they are formed U-shaped with an upwardly extending holder shaft 38d at the free end of which there is arranged a foot piece 38e with a latch nose 39b standing out therefrom. In the case of the holder webs 38b engaging below in each case the latching nose 39a stands transversely out from the holder limb 38c. As in particular FIGS. 3, 6 and 7 show, the holder mountings 40a, 40b so far described are arranged in the lateral end regions of the panels 2 whereby they are preferably offset horizontally in the plane of the panels 2 so that when taking into consideration the size of the gap in the region of overlap between the outer panes 17 it is not necessary to account for the double thickness of the holder mountings 40a, 40b and the gap can be kept small.

For additional or sole securing or attachment of the holder mountings 40a, 40b in the groove 25 there may be provided in each case a bolt S which transversely passes through the holder web 38c or the foot piece 38e and is screwed into at least the profile strip 23, preferably of metal, or also into the bonding material 21. Such a bolt S is indicated in FIG. 5 in each case by means of a middle line and a small schematic of a bolt head.

Furthermore, it is advantageous to dimension the limbs or sections of the holder mountings 40a, 40b so long that there is present between them and the outer pane 17, here at least between the holder webs 38a, 38b, the holder limbs 38c and the holder shafts 38d, and the associated outer pane 17 a vertical or horizontal spacing which frees the outer pane 17 from pressure loading. Only then if the outer pane 17 frees itself from its adhesive attachment and falls into the claw-shaped holder webs 38a does physical contact between these parts arise. In the normal condition there need be no contact between the holder mountings 40a, 40b and the outer pane 17, since here only safety parts are involved.

For a facade shell 1 of the kind under consideration, the panels 2 of which should, in the closed position, close off the space found behind the thus formed shell so far as possible in a sealed manner, various sealing zones are of significance. A first sealing zone is arranged in each case in the gap region between two panels 2 arranged one over another. A second sealing zone is present in the lateral edge region of the panels 2, whereby depending upon the constitution of the sealing different sealing configurations may be realised in the first or in the second zone. In the region of the gap 26, the sealing may is be effected e.g. by means of a single sealing profile which extends in the longitudinal direction of the pane edges and is attached to the edge of one of the two panes, or there may also be provided two sealing profiles of which each is secured to the edge of the associated pane and which carry out their sealing function by mutually pressing on one another.

With the above-described configuration of the panels 2 with a groove 24 which extends at least at the upper and/or lower edge 15a, 15b of the panel 2 concerned, it has proven that they are excellently suited for holding a sealing profile in that profile sections arranged on the sealing profile are placed in the groove 24 and attached e.g. by means of gluing, clamping or form-fitting latching. The latter two attachment features are not unavoidably necessary if the sealing profile is held in some other manner in its working position, e.g. in that it is arranged around the periphery and due to its surrounding is arranged in a form-fitting manner in the groove 24, likewise formed as a surrounding ring groove.

For the above-mentioned reasons there is thus needed for the sealing of the gap 26 only one sealing profile 41 which with the present configuration is formed with a flat cross-section, but which could also have a different cross-sectional shape, e.g. a round cross-sectional shape. At the bearing side 42 of the sealing profile 41 an attachment strip 43 is formed on, which strip engages into the groove 24 and can be latched therein, preferably with a mushroom-head-like cross-sectional shape. As sealing profile 41 as so far described may by itself, or with a corresponding sealing profile 41 arranged on the opposing edge of the other panel, bring about a satisfactory sealing of the gap 26 when the respective cross-sectional dimensions are sufficiently large that the individual sealing profile 41 and the opposing edge co-operate in a sealing manner or two sealing profiles 41 co-operate with one another in a sealing manner. The sealing can also be brought about by means of a sealing lip 44 which assumes the sealing function in the sense described above. Since in the case of a building pressure effects or suction effects are to be expected, depending on wind direction, it is advantageous to form the sealing in the gap 26 with two sealing strips which in the through direction of the gap are arranged one after another and of which one sealing lip 44 having an outwardly directed counter sealing surface 46 and the other sealing lip 44 having an inwardly directed counter sealing surface 47 co-operate. By these means the sealing is improved because the first mentioned sealing lip 44, in the case of pressure effects, bears against the counter sealing surface 46 and brings about a good sealing, whereas the second sealing lip 44 brings about this sealing in the case of a suction effect.

It is further advantageous to arrange the sealing lip 44 on the base profile 41a which carries it at a spacing e from a side surface, here from the first counter sealing surface 46, which approximately corresponds to the offset v by which the upper and the lower insulation units 15 are in each case offset transversely with respect to the panes. This leads to the advantage that with an arrangement of two identical sealing profiles 41 on the upper and lower edge in the gap 26, the one sealing lip 44 with the side surface of the oppositely lying base profile 41a can function as a pressure sealing and the other sealing lip 44 with the oppositely lying base profile 41a and its inwardly directed side surface, here the counter sealing surface 47, can function as a suction sealing. By reason of the identity and the reverse arrangement of the sealing profiles 41 there can thus be achieved in a simple and economical manner an excellent sealing having two sealing functions.

Furthermore, it is advantageous to form the sealing profile 41 so that it runs around the associated panel 2 and is thus ring-like. By these means the attachment of the sealing profile 41 is on the one hand stabilised due to its surrounding the panel and is also fixed in the peripheral direction so that no further measures are needed for securing the sealing profile 41. This applies also for such a configuration as is considered here in which the base profile 41a, preferably formed in the shape of a flat or quadrilateral tube, is connected at one side or here only at its one end with the attachment strip 43, whilst the remaining section of the base profile 41a bears against the surrounding surface of the associated panel 2. Due to the ring shape this bearing is reliably ensured.

With the present configuration a small gap is present, as shown in FIG. 5, between the two base profiles 41a lying opposite one another in the gap 26.

For sealing the vertical edge regions of the panels 2 a vertical sealing strip 48 (FIGS. 4 to 6) is in each case arranged in the two lateral end regions of the facade shell 1, the end surface of which sealing strip facing outwardly is formed in a saw-tooth shape, following the inner surface of the panels 2 arranged one above another and the respective offset, whereby its outwardly directed projection, predetermined by means of the saw-tooth shape, decreases with increasing height. In order to improve the sealing it is advantageous to associate with the sealing strip 48 a sealing ribbon 49 which runs upright and which runs between the sealing strip and the panels 2 and improves the sealing. With the present configuration, this sealing ribbon 49 is formed of vertical sections of a sealing profile, which is preferably the sealing profile 41, whereby the sections bear on the inner side on the thin side periphery of the insulation pane unit 15. In this case, the base profile 41a of the sealing profile 41 is formed in an angled shaped with a sealing limb 41b, preferably in the form of a flat tube, bearing against the narrow side peripheral surface, and a sealing limb 41c, which is preferably likewise tube-shaped, in particularly flat tube-shaped, and engaging behind the inner side of the panel 2 and bearing upon the inner side, and preferably formed with its own hollow space. Due to the ring-shape of the sealing profile 41 there are provided vertical and horizontal sections of the sealing limb 41c on the lateral and horizontal edges of the respective panel 2.

The sealing strip 48 is arranged in the region of the vertical sections of the sealing limbs 41c arranged one above another, whereby these co operate with the sealing side surfaces 48a of the sealing strip and the section of the sealing limb 41b having the sealing step surface 48b in each case arranged therebetween. Insofar as the associated sealing lip 44 is present this fits into the vertical chain of the sealing ribbon sections, whereby in this case the sealing strip 48 has a sealing shape surface 48c, here an oblique surface, adapted in each case to the shape of the sealing lip 44. On the opposite side of the facade shell 1 there is formed and arranged in a corresponding mirror-image manner a second sealing strip 48 with such a sealing ribbon 49.

As FIG. 2 in particular shows the upper edge of the uppermost panel or insulation unit 15 and the lower edge of the lowermost panel 2 or insulation unit 15 are sealed in each case by means of a horizontally extending sealing strip 50a, 50b, which co-operate with the sealing limb 41b or 41c and against which the panel with these sealing profile sections presses.

Consequently the space located behind the facade shell 1 is sealed by means of two lateral, substantially vertical sealing strands 51 and in the region of each gap 26 by means of at least one, here two horizontal sealing strands 52.

In order to protect the gap from driving rain there is provided in the overlap region between the outer panes 17 a horizontal, preferably tube-shaped sealing profile 53 as a driving rain seal, which preferably is arranged and attached, e.g. by gluing, at the upper edge of the inner outer pane 17. With the present configuration, this sealing profile 53 has a base body 53a bearing with a broad side on the outer pane 17 and a base body limb 53b which engages over the outer pane 17. The thickness of the sealing profile 53 is greater than the thickness of the holder webs 38a, 38b, or their sections passing through the sealing profile 53, so that the horizontal spacing at this location between the outer panes 17 and the holder webs 38a, 38b can be maintained. In the regions in which the holder webs 38a, 38b are located the sealing profile 53 is cut out with appropriate shape and size. This applies also to the limbs 41b, 41c of the sealing profile 41 with regard to the holder webs 28a, 28b.

As can be seen in particular from FIG. 6, the sealing strips 48 are in each case located in the region of an inner wall 12a of a box profile 12 forming the associated vertical carrier frame part 6a, whereby the outer wall 12b of the box profile 12 projects outwardly beyond the inner wall 12a, so that the facade shell 1 is arranged between the outer walls 12b of the lateral carrier part 6a. Thereby a free space 54 is present between the side edges of the panels 2 and the outer wall 12b into which the vertical section of the sealing profile 41 projects with the associated section of the sealing lip 44.

At the lateral edges of the panels 2, here of the insulation units 15, there is attached in each case a further sealing profile 55 which co-operates in a sealing manner with the inner surface 12c of the outer wall 12b which extends so far outwardly that at least in the closed position the sealing profile 55 is in contact with the inner surface 12c. The sealing profile 55 is held with an attachment strip 55a in a holder profile 56 which is attached or preferably latches with a support limb 56a bearing on the outer surface of the associated outer pane 17 and a holder limb 56b engaging over the edge of the outer pane 17 and engaging into the second groove 25 in an angled shape.

As FIG. 4 shows, there are located at an end spacing from the lateral carrier parts 6a of the assembly element 7 two carrier profiles 35 on which in each case a slider 33 is guided vertical displaceably, which carrier is connected in a jointed manner with the holder arms 27.

With the exemplary embodiment according to FIG. 3 there is arranged in each horizontally extending row only one panel 2 or insulation unit 15, whereby laterally next to the outer walls 12b there adjoins an outer shell e.g. of insulating glass 57. In the carrier frame of the invention it is possible to arrange a plurality of panels 2 or insulation units 15 next to one another in a horizontal row and to bring them together in one movement unit, whereby all panels 2 or insulation units 15 of the unit can be pivoted out and in simultaneously. The lateral abutments of such panels 2 or insulation units 15 lying next to one another can be sealed by means of sealing means such as seals or a silicone filler sealing. With such a configuration the vertical sealing strand 51 with sealing strips 48 is likewise needed only in the lateral end regions. Thereby it is advantageous to arrange at least one, here both, sealing profiles 41 around all panels 2 or insulation units 15 of the movement unit 15. With such a configuration the sealing profiles in each case thus surround a row of the panels 2 or insulation units 15. This is also possible with a prefabricated assembly frame 7 of the kind considered here, when this is longer than one panel 2 or insulation unit 15 so that a plurality of panels 2 or insulation units can in each case be arranged in a row and form one movement unit, whereby the panels 2 or insulation units 15 of the or each row are surrounded by one sealing profile 41.

The horizontal length of the movement unit may extend over a plurality of posts 8. With the presence of a carrier frame 6 in accordance with FIGS. 2 and 4, the movement unit can extend horizontally likewise beyond the horizontal length of the carrier frame 6 or over a plurality of carrier frames 6 arranged horizontally next to one another. In this case, the lateral carrier parts 6a, 6b are to be so narrow at their outer edges that the panels 2 or the movement units can extend laterally beyond the carrier parts 6a, 6b. In the carrier frame of the invention a drive 5 can be associated with the holders 3 in each case of one carrier frame as a common drive, or it is also possible to associate a common drive 5 with a plurality of carrier frames 6 arranged horizontally next to one another.

The exemplary embodiment according to FIG. 10, in which the same or similar parts are provided with the same reference signs, differs from the exemplary embodiments according to FIGS. 2 to 6 in that the panels 2 are formed not by means double panes but by means of a single plate, in particular of glass, e.g. louver glass. Here, the panels 2 may be engaged below or above with angle-shaped holder webs for the purpose of holding them in place, as can be seen from FIG. 10 of WO 96/06258 and as is described in the introduction. With such simple panels 2 a sealing profile, corresponding to the sealing profile 41 according to FIGS. 5 and 6, may be arranged in a surrounding manner with a profile limb 41b bearing against the narrow side of the respective panel 2 and a profile limb 41c bearing on the edge of the inner side and, in contrast to the exemplary embodiment according to FIGS. 5 and 6, can be attached in a different manner, e.g. by gluing, whereby the attachment web 24 can be omitted. As with the exemplary embodiment according to FIGS. 6 to 8, also with the exemplary embodiment according to FIG. 10 there can be provided a saw-tooth-shape sealing strip 48 in the lateral end regions of the carrier frame 6, preferably in or on the lateral carrier parts 6a, 6b, which co-operates in a sealing manner with a sealing profile of the vertical sections of the sealing profiles 41 present on the panels 2 arranged one above another, as FIG. 6 shows and is described in the related part of the description. As with the above-described exemplary embodiments of the carrier frame 6, the carrier parts 6a, 6d here also have an inwardly outstanding attachment web 6f at their inner edges, which attachment web e.g. may be of angle-shape with a limb directed towards the carrier frame middle and which serves for attachment with the post 8 and bars 9 by means of non-illustrated attachment elements which engage over and behind, in particular in a form-fitting manner, the attachment web 6f. The width g of the carrier parts or of the carrier frame extending transversely to the carrier frame plane corresponds approximately to the width h of the post 8 and bar 9.

The exemplary embodiment according to FIG. 12, in which the same or similar parts are likewise provided with the same reference signs, differs from the exemplary embodiments according to FIGS. 2 to 10 in several respects.

On the one hand, the inner shell 1a is connected with the inner edges of the carrier parts 6a to 6d and attached thereon, preferably attached exclusively thereon.

Further, there is integrated into the carrier frame 6 a light or sun protector 61 between the outer shell 1b and the inner shell 1a, which in the case of the present exemplary embodiment is formed by means of a curtain 61a which can be lowered and raised, which is formed of panels 61b arranged above one another and pivotable around a horizontal axis or by a foil or a cloth and can be lowered or raised by means of a non-illustrated motorised or manually driven adjustment mechanism which is accessible from the interior, as is per se known for jalousies. The light or sun protector 61 is attached on the upper carrier frame part 6d by means of an upper carrier beam 61c. For the purpose of increasing the vertical size of the opening the carrier beam 61c is preferably arranged at least partly in the upper carrier frame part 6d at least partly sunk into a recess 6g.

Further, the carrier parts 6a, 6d are thermally separated in a composite web construction in the form of an inner and outer shell 6x, 6y, as will be described further below.

The inner shell 1a can be provided with different constructions. It may be formed e.g. by means of a light weight wall, in particular in double shelled and thermally insulated construction, by means fixed glazing, in particular with insulation units (FIGS. 14 to 16), of a plurality of plates or by means of a window without or with a pivotable pane, whereby such a wall, generally designated by 1c, may correspond to the horizontal and vertical dimensions of the carrier frame 6 or may be sub-divided into vertical wall strips 1c1, 1c2 which in each case may extend from a lateral carrier frame part 6a or 6b to a carrier support 35 or may extend from one to the neighbouring carrier support 35. The wall 1c or the wall parts 1c1, 1c2 are in each case attached by means of holder frame parts 62 extending on their peripheral edges horizontally and vertically in a strip-like manner, which parts are in each case attached to the associated carrier frame part 6a to 6d of the carrier frame 6, preferably are formed thereon in one piece.

It is advantageous, for technical manufacturing reasons and for reasons of costs, to form the carrier parts 6a to 6d by means of profile rods. Taking into consideration that the holder frame parts 62 should preferably be formed on in one piece and/or taking into consideration the thermally separated bonding manner, there can be attained by these means a simple and rational and also economical fabrication or prefabrication of the carrier parts 6a to 6d and the holder frame part 62.

FIG. 12 shows an upper carrier frame part 6d and the attachment of a wall 1c or of a wall part 1c1 to the carrier frame part 6d in vertical cross-section. The carrier parts 6a to 6d may, with regard to their width g directed transversely to the carrier frame plane, be formed in one piece as FIG. 12 shows, or in different pieces and e.g. be assembled of a plurality of profiles which are attached to one another, e.g. inserted into one another in a form-fitting manner, as e.g. FIG. 6 shows in the middle region of the here lateral carrier frame part 6a, with which e.g. a thermally separated profile is not involved. The configuration according to FIG. 12 shows in contrast a composite construction of the carrier frame part 6d with thermal separation. The carrier frame part 6d or the associated profile rod consists of the inner shell 6x and the outer shell 6y which in a manner known per se are connected by means of webs 6z of reduced thermal conductivity, e.g. of plastics. This composite structure can also be realised likewise in a manner known per se in the prefabrication of the profiles, so that these must then be cut off to adapt their length. The middle of the thermal separation is indicated for the overall carrier frame 6, including the inner shell 1a, by means of a dividing line TL. If the carrier frame 6 is formed with an assembly flange 13 it is advantageous to include the assembly flange 13 in the thermal separation, as is illustrated, whereby its inwardly arranged shell part 13a is connected in one piece with the outer shell 6x of the carrier frame part 6d.

Preferably the associated holder frame part, here the upper horizontal holder frame part 62, is also included in the thermal separation, and thus divided up by means of two profile sections 62x, 62y, of which the first is part of the inner shell 6x and the latter is part of the outer shell 6y. With the present configuration, the profile sections 62x, 62y have a spacing from one another. The inner profile section 62x serves for bearing and holding the wall 1c, while the outer profile section 62y serves for the attachment of a clamping strip 63 which bears on the inner side of the wall part edge and is connected with the outer profile section 62y by means of a bolt 64, whereby there is preferably arranged on the outside of the bolt a support web 65 between the profile section 6x and the clamping strip 63, which in the case of the present exemplary embodiment is a separate web. For the engagement there is preferably provided a so-called bolt channel 66, here extending longitudinally of the upper carrier part 6d or holder frame part 62, in the form of a groove in the profile section 62x. Between the wall 1c and the profile section 62y on the one hand and the clamping strip 63 on the other hand there are preferably arranged sealing profiles 67, 68 which in each case are in particular held with a mushroom-head-like attachment strip in an undercut groove in the facing end surface of the profile section 62y and of the clamping strip 63. The clamping strip 63 forms a separate counter-piece of the holder frame part 62 or 62y when a thermal separated profile is involved. For reason of the engagement over and behind the wall 1c with the bolt 64 and the clamping part 63, the wall 1c is to be smaller by the amount h than the carrier frame 6 or the associated carrier parts 6a to 6d.

A thermal separation of the clamping strip 63 is provided by its spacing. Additionally, the shafts of the bolts 64 may be of thermally insulating material such as plastics.

The lower carrier part 6c, arranged below, and the holder frame part 62 arranged below are correspondingly formed in a mirror-image manner. This applies also for the two vertical carrier parts 6a, 6b and the holder frame part 62 extending on them. Therefore, for reasons of simplification, a corresponding description for the other carrier parts 6a to 6c and the respectively associated holder frame part 62 is not needed.

With the configuration according to FIG. 12, the wall 1c is formed at least in the upper region by means of a window having a window frame, a window leaf and a pane preferably formed as an insulation unit. There are illustrated only the upper window frame transom 69 and the upper leaf transom 71, and also the pane 72. The window frame is held on the holder frame part 62 by means of an e.g. tapered assembly flange 73. Also the window frame and the window leaf are of thermally separated profiles in a composite construction, as is clearly shown in the drawing. The relevant inner and outer shells are designated with 69x, 69y, 71x, 71y and 73x, 73y.

The exemplary embodiment according to FIG. 13 shows an attachment detail in the case of one or more carrier support 35, which extend from the lower to the upper carrier 6c, 6d and are fastened thereon, when the carrier supports 35 (in the present exemplary embodiment, two of them) is or are involved in the attachment of at least one or two neighbouring wall parts 1c1, 1c2. With this configuration there are formed on both sides of the carrier support 35, likewise formed by means of a profile rod, in each case a vertical holder frame part 62 which with the present exemplary embodiment stand out laterally from the carrier support 35 and can be attached to the wall parts 1c1, 1c2, e.g. by means of a vertical clamping strip 63 which engages over one or both wall parts 1c1, 1c2, which clamping strip is bolted (not shown) against the carrier support 35 or connected by means of a draw connection. With the illustrated configuration, the right hand wall part 1c1 is formed by a window, whereby the carrier support 35 forms a vertical transom of a window frame, with the vertical holder frame part 62 and/or with a holder frame web 35a outstanding inwardly between the wall parts 1c1, 1c2 and preferably tapered, on which vertical transom the vertical leaf transom 71 of an associated window leaf finds a stop. The left hand wall part 1c2 is a plate 72 of fixed glazing in the form of an insulation unit, which bears on the holder frame part 62 present at this side of the carrier support 35, e.g. arranged or formed in a mirror-image manner, and at its inner side is supported by means of a clamping strip 63 in the form of glass retaining strip 74, which e.g. is attached, e.g. latched, in a form fitting manner on the holder frame web 35a. The holder frame web 35a is preferably thermally separated from the base body of the carrier support 35 in the usual and already described composite construction with connecting webs 6z, c.f. the thermal separation line TL. In this case two holder frame web parts are present which are indicated as parts of the inner and outer shells as 35ax and 35ay.

With the exemplary embodiment according to FIG. 14 there are present two wall parts 1c1, 1c2 each formed by means of a fixed glazing, and which are supported on two vertical holder frame parts 62 projecting inwardly at their end faces, which may be formed in an angle-shape with limbs directed towards one another, whereby they form an undercut vertical attachment groove 75, in which the head of a tensioning bolt 64 sits, by means of which a clamping strip 63 is bolted against the edges of the wall parts 1c1, 1c2 facing one another by means of a nut 64a. Also with this exemplary embodiment, sealing profiles 67, 68 may be arranged between the wall parts 1c1, 1c2 and the holder frame parts 62 and also the clamping strip 63 which can engage with fastening strips into undercut fastening grooves (not shown) in the bearing surfaces of the holder frame part 62 and the clamping strip 63. With this configuration at least the bolt shaft may be of a thermally insulating material, e.g. plastics, by which means a thermal separation is achieved in addition to the spacing of the clamping strip 63.

A similar configuration is provided with the exemplary embodiment according to FIGS. 15 and 16, whereby however between the holder frame part 62 of the carrier support 35 there is provided a vertical fastening web 35b having a bolt channel 66 for a bolt 64 which is bolted together with a clamping strip 63 engaging over both edges of the wall parts 1c1, 1c2. With this exemplary embodiment, the left hand wall part 1c2 is formed as fixed glazing, whereas the right hand wall part 1c1 is formed as a window the vertical window frame transom 69 of which is held between the associated holder frame part 62 and the clamping strip 63. A corresponding configuration is illustrated in FIG. 16 in a mirror-image manner. 63a designates a covering strip 63a for the clamping strip 63 which is releasably latchable into the clamping strip with fork-like limbs engaging over the clamping strip.

With the exemplary embodiments according to FIGS. 15 and 16 the carrier support 35 present in each case forms a vertical guide 76 for the curtain 61a of the light or sun protector 61, which with these two exemplary embodiments has pivotable slats 61b, which are connected with one another by means of vertical ribbons 61c and are pivotable. With the exemplary embodiment according to FIG. 15, the guide 76 is formed by means of vertical guide groove 77, whereby the horizontal length of the curtain 61a is so large that the curtain 61 enters into the guide groove 77 with play for movement. For a curtain 61a present on the other side of the carrier support 35 there is provided a correspondingly formed guide groove 77, whereby the carrier support 35 attains a waisted cross-sectional shape. This configuration and arrangement leads to a further advantage. Because of the entry of the curtain into the preferably quadrilateral guide groove 77, a vertical gap between the curtain 61a and the carrier support 35 is avoided, through which light could get to the interior, and there is thus attained by overlapping a complete shading of the interior space by means of an overlapping between the curtain 61a and the carrier support 35. The horizontal width of the guide groove 77 is, when pivotable slats 61b are present, to be sufficiently large that the slats can engage therein in their horizontal position, with play for movement. A corresponding configuration with a vertical guide groove 77 is also provided at the inner sides of the lateral carrier parts. 6a, 6b.

With the exemplary embodiment according to FIG. 16 there is likewise arranged a preferably undercut guide groove 78 at both sides of the carrier support 35, whereby on the curtain 61a, in particular at its lower end, on both sides a respective guide bolt 79 projects horizontally, in the plane of the curtain, which bolt engages into the associated guide groove 78 and is guided therein. The guide bolt 79 may have a mushroom-shaped head with which it engages behind the undercut guide groove 78, whereby an undesired emergence of the guide bolt 79 out of the guide groove 78, e.g. in the case of a bending of the curtain 61a under wind pressure, is prevented. In order to avoid wear of the guide bolts 79 upon vertical displacement, there may be arranged in the guide webs 81 forming the undercutting of the respective guide groove 78, vertical receiving grooves 82 in which guide strips of guide-aiding material, e.g. of soft material such as plastics or rubber, are arranged which protect the guide bolt 79 or a shaft from wear and furthermore make possible a displacement with little noise. In order to prevent the guide strips 83 coming out of the receiving groove 82, these may have an undercut form behind which the guide strips 83 engage.

Within the scope of the invention it is possible to form the carrier frame 6 at the site of installation in that the carrier parts 6a to 6d are attached at the soffit walls of an installation opening, e.g. at the building wall itself or at a carrier construction having vertical posts 8 and horizontal bars 9. Then, the carrier supports 35, the adjustment or pivoting devices 4 and the slat pieces 2 forming the outer shell 1b can be mounted. Further, inwardly, the inner shell 1a can be mounted on the carrier parts 6a to 6d or the carrier frame 6. With this arrangement there is needed no corner attachment of the carrier parts between one another, since the carrier arrangement (carrier construction, building) provides the carrier frame 6 with the stability.

It is of particular advantage to so configure the carrier frame 6 that it is per se stable, so that with its associated holder elements for the panels 2 and the wall parts 1c it can be prefabricated at its place of manufacture (workshop) or at the construction site and the unit prefabricated to this extent can be mounted on the building. In particular when the panels 2 and the wall parts 1c are of glass these can be mounted later. With the present exemplary embodiment the configuration of the carrier frame 6 which is itself stable is ensured by means of a fastening of the carrier parts 6a to 6d at their ends towards one another. This is achieved by means of the corner angle 6e, with which the carrier parts 6a to 6d are connected, e.g. by means of bolts 6s (FIG. 6). It is particularly advantageous to so form the carrier parts 6a to 6d that the limbs of the corner angle 6e are held in a form fitting manner on the carrier parts 6a to 6d. In particular in the case of carrier parts formed of profile rods this can be achieved in particular by means of inner profile grooves 6h to the dimensions of which the limbs of the corner angle 6e are adapted and thus sit therein in a form-fitting manner.

With a variant of the invention, the holder frame parts 62 for the inner shell 1a are likewise formed on in one piece on the carrier parts 6a to 6d. Here, however there are involved carrier parts 6a to 6d which in transverse plane of the carrier frame do not extend up to the inner shell 1a but are narrower, and which in each case can be attached as individual parts to the carrier construction or to the building itself. With this configuration, the carrier parts 6a to 6d and the holder frame parts 62 can be manufactured and prefabricated at the same time, in particular as profile rods. At the construction site there is then needed no particular installation of the holder frame part 62, but only of the carrier parts 6a to 6d. For this reason, both the manufacture and also the installation is substantially simplified, whereby the manufacturing costs can be significantly reduced. Carrier frame parts 6a to 6d and holder frame parts 62 combined in the above-described manner can be installed e.g. with a manner of construction in accordance with FIG. 1, in which a carrier frame 6 which is stable in itself and prefabricatable is not provided.

Within the scope of the invention it is however possible to form the above-described narrow carrier parts 6a to 6d, which do not extend from the inner shell 1a up to the outer shell 1d, with or without the formed on holder frame parts 62 as a carrier frame 6 which is in itself stable. The self-stability can be attained by means of fastening devices 10 with which these narrow carrier parts are connected with one another in their end regions towards one another, e.g. by means of corner angles 6g, as have been described for the narrow carrier frame according to FIGS. 2 to 10, which only supports or carries the outer shell 1b.

With a carrier frame as described above, narrow and stable in itself, supporting or carrying only the inner shell 1a, various advantages relating to the inner shell 1a can be attained.

It is further possible within the scope of the invention to provide the facade shell 1 in accordance with the invention in the region of the entire building facade or only in one or more partial regions of the building facade. The latter is shown e.g. in FIGS. 1 to 4 and 10 and 11, in which the facade shell in accordance with the invention is provided only in part region of the building facade, namely in the region of a carrier frame 6 the horizontal and vertical external dimensions of which, taking into consideration a tolerance for installation, are adapted to the horizontal and vertical dimensions of the installation opening 11 in the post/bar construction or in a building. Thereby, the vertical dimension may correspond approximately to the storey height or storey internal height of the building.

The exemplary embodiment according to FIG. 1, in which the same or similar parts are provided with the same reference signs, differs from the exemplary embodiment according to FIG. 11 in principle only in that the likewise present horizontal and vertical carrier parts 6a, 6b, 6c, 6d are not connected by means of an attachment device 10 to a frame or carrier which is itself stable, but the carrier parts 6a to 6d can be attached to the concrete or the wall of the building or to a post/bar construction and thus obtain stability directly via these building parts. For the one or more carrier supports 35 there is needed in contrast an attachment of their lower and upper ends to the lower and upper horizontal carrier parts 6c, 6d in each case by means of an attachment device 10. Further, also in accordance with FIG. 1, the carrier parts 6a to 6d and the carrier supports 35 are formed in one piece with the formed on holder frame parts 62 of the inner shell 1a. Furthermore, the inner shell 1a is connected by means of the carrier parts 6a to 6d with the outer shell 16 and thereby supported. Further, a light or sun protector 61 is also provided with the configuration of FIG. 1.

Within the scope of the invention it is possible to arrange at the upper and lower edge of a wall part 1c of the inner shell 1a, or between two wall parts arranged one above another (in FIG. 1 a window and window glazing) horizontal auxiliary bars 9a which may be smaller in their cross-sectional size. The holder frame parts 62 may be formed on both on the upper and lower carrier parts 6c, 6d or the normal bars 9, or on the auxiliary bars 9a.

With the above-described configurations, the carrier parts 6a to 6d may also be formed by means of the post/bar construction (8, 9).

1. Adjustable facade shell for a building comprising:
an outer shell comprising panels which are pivotally moveable between a closed position and an open position;
an inner shell, spaced from the outer shell and comprising one or more plates;
a carrier frame attached to the building and having an exterior side aligned with an outside edge of an exterior wall of the building, the carrier frame comprising vertical and horizontal carrier parts connected to and supporting the plates of the inner shell, the carrier parts comprising ends, wherein adjacent ends are rigidly connected to one another by means of a corner angle to form a stable carrier frame, the carrier frame comprising one or more carrier supports disposed between the vertical carrier parts and attached to one or more of the horizontal carrier parts, wherein the carrier parts and the carrier supports comprise hollow profile rods, and one of the carrier parts and the carrier supports comprise profile recesses into which limbs of each corner angle fit; and
pivot devices connected to the carrier frame and the panels of the outer shell and capable of moving the panels between the open and closed positions;
wherein the panels when in the open position and when moving between the open and closed positions are located in front of the exterior side of the carrier frame.

2. (Canceled)

3. (Canceled)

4. (Canceled)

5. (Canceled)

6. (Canceled)

7. (Canceled)

8. (Canceled)

9. (Canceled)

10. (Canceled)

11. (Canceled)

12. Adjustable facade shell for a building comprising:
an outer shell comprising panels which are pivotally moveable between a closed position and an open position;
an inner shell, spaced from the outer shell and comprising one or more plates;
a carrier frame attached to the building and having an exterior side aligned with an outside edge of an exterior wall of the building, the carrier frame comprising vertical and horizontal carrier parts connected to and supporting the plates of the inner shell; and
pivot devices connected to the carrier frame and the panels of the outer shell and capable of moving the panels between the open and closed positions each pivot device comprising a slider mounted in a guide extending along one of the vertical carrier parts;
wherein the panels when in the open position and when moving between the open and closed positions are located in front of the outer side of the carrier frame.

13. Adjustable facade shell according to claim 12, wherein each pivot device further comprises:
a holding arm arranged to hold one of the panels, the holding arm pivotally connected to the slider; and
a support arm having a first end pivotally connected to the holding arm and a second end opposite the first end pivotally connected to one of the vertical carrier parts.

14. Adjustable facade shell according to claim 12, wherein the carrier parts comprise holder frame parts and the plates of the inner shell are attached along peripheral edges to the holder frame.

15. Adjustable facade wall according to claim 12, wherein the carrier parts comprise ends, and adjacent ends are rigidly connected to one another by means of a corner angle, to form a stable carrier frame.

16. Adjustable facade shell according to claim 12, wherein the carrier frame comprises one or more carrier supports disposed between the vertical carrier parts and are attached to one or more of the horizontal carrier parts.

17. Adjustable facade shell according to claim 16, wherein each pivot device is attached to and supported by on one or more of the carrier supports.

18. Adjustable facade shell according to claim 1, wherein in the closed position the panels are in sealing contact with the carrier frame in the region of its outer edge.

19. Adjustable facade shell according to claim 15, wherein the carrier frame comprises one or more carrier supports disposed between the vertical carrier parts and are attached to one or more of the horizontal carrier parts, the carrier parts and the carrier supports comprise hollow profile rods, and one of the carrier parts and the carrier supports comprise profile recesses into which limbs of each corner angle fit.

20. Adjustable facade shell according to claim 14, wherein one or more of the plates of the inner shell comprises a window and the holder frame parts comprise window frames.

21. Adjustable facade shell according to claim 16, wherein the carrier supports comprise integral holder frame parts.

22. An adjustable facade shell for a building comprising:
an outer shell comprising panels which are pivotally moveable between a closed position and an open position;
an inner shell, spaced from the outer shell and comprising one or more plates;
a carrier frame attached to the building and having an exterior side aligned with an outside edge of an exterior wall of the building, the carrier frame comprising vertical and horizontal carrier parts connected to and supporting the plates of the inner shell;
pivot devices connected to the carrier frame and the panels of the outer shell and capable of moving the panels between the open and closed positions, each pivot device comprising a slider mounted in a guide extending along one of the vertical carrier parts;
wherein the panels when in the open position and when moving between the open and closed positions are located in front of the exterior side of the carrier frame and at least one of the plates of the inner shell comprises a window pane.
